(19) United States
(12) Patent Application Publication
(10) Pub. No.: US 2008/0277972 A1
(43) Pub. Date: Nov. 13, 2008

(54) Roller Skid Plate with Quick Disconnect Isolation Mounts

(76) Inventor: Ronald William Bonofiglio, JR., Tolland, CT (US)

Correspondence Address: Ronald W. Bonofiglio, Jr., 110 Chardonnay Lane, Tolland, CT, 06084, US

(21) Appl. No.: 12/117,722

(22) Filed: May 8, 2008

Related U.S. Application Data
(60) Provisional application No. 60/928,501, filed on May 10, 2007.

(51) Int. Cl. B62J 27/00

(52) U.S. Cl. 296/204

(57) ABSTRACT

An undercarriage skid plate consisting of a structural frame, heavy-duty rollers, mounting brackets, quick disconnect attachment means, and impact isolation mounts, primarily for use on off-road vehicles. The roller skid plate frame houses an array of heavy duty rollers with axes of rotation the same as the wheels of the vehicle. Mounting brackets are directly attached to the vehicle frame with appropriate fasteners. The skid plate frame is secured to the brackets with quick-disconnect fasteners inserted through impact absorbing bushings. The roller skid plate provides protection to vehicle undercarriage components while also reducing the amount of frictional drag generated when a vehicle encounters an off-road hazard. The quick disconnect mounts allow for easy removal of the skid plate for such purposes as to service the vehicle. The isolation mounts reduce the force conducted through vehicle's frame when impact with an off-road hazard is made.

### CROSS-REFERENCE TO RELATED APPLICATIONS

| | | | | |
|---|---|---|---|---|
| 1,182,378 | A | May 1916 | Jewell | 180/69.1 |
| 3,137,466 | A | May 1962 | Warren | 248/9 |
| 3,508,745 | A | May 1970 | Deane | 267/57.1 |
| 3,779,330 | A | December 1973 | Longpre | 180/69.1 |
| 3,825,284 | A | July 1974 | Behrle | 280/515 |
| 3,826,327 | A | July 1974 | Stover | 180/69.1 |
| 3,865,407 | A | February 1975 | Klassen | 280/515 |
| 4,099,739 | A | July 1978 | Foley | 280/504 |
| 4,114,717 | A | September 1978 | Andrews | 180/69.1 |
| 4,298,212 | A | November 1981 | Jamison | 280/515 |
| 4,407,381 | A | October 1983 | Oswald | 180/6.48 |
| 4,655,307 | A | April 1987 | Lamoureux | 180/69.1 |
| 5,992,926 | A | November 1999 | Christofaro et al. | 296/204 |
| 6,193,260 | B1 | February 2001 | Haman et al. | 280/515 |
| 6,202,778 | B1 | March 2001 | Mistry et al. | 180/69.1 |
| 6,206,407 | B1 | December 1998 | Fuchs et al. | 280/68.6 |
| 6,516,907 | B2 | February 2003 | Robinson | 180/69.1 |
| 6,726,273 | B2 | April 2004 | Kruschhausen et al. | 296/204 |
| 7,055,895 | B1 | June 2006 | King et al. | 296/204 |

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

This invention is an innovation to land vehicle skid plates, specifically for off-road motor powered land vehicles. This invention relates to protection devices typically mounted to the undercarriage of motorized land vehicles, with the purpose to protect vulnerable components such as the engine, oil pan, transmission, transfer case, and the like from damage caused by impact with an off-road hazard or obstacle.

2. Description of Related Art

Motorized land vehicles, specifically of the off-road variety, have employed the use of skid plates to protect vulnerable undercarriage components from damage. Skid plates known in the art are typically constructed of plates of steel, aluminum, or other metal alloys, which cover the area of the vulnerable component and are rigidly mounted to the frame or unit body structure of the vehicle.

Due to the construction of the known skid plates, with typically flat sheets of metal, the coefficient of friction between the known skid plate and any trail hazard or obstacle is large. Due to the rigid mounting of the known skid plate to the frame of the vehicle, a large portion of the weight of the vehicle will be transferred to the contact point between the known skid plate and the trail hazard. This large portion of vehicle weight combined with the high coefficient of friction can create enough drag to impede the intended motion of the motorized land vehicle. The force required to overcome this drag force and move the vehicle in the intended direction can easily be greater than the available torque between the tires of the vehicle and the ground, resulting in tire slippage, potentially resulting in damage to the motorized land vehicle and the trail.

The mounting means of attaching the known skid plates to a vehicle is typically accomplished through rigid mounting means. This method of attachment provides no means of impact absorption, thereby transmitting the entire force of impact through the skid plate to the vehicle. Transmittal of this impact force can be severe enough to cause damage to the vehicle for which the skid plate is designed to protect. This complete transfer of impact force to the vehicle can be jarring and undesirable to the occupants of the vehicle. One known exception to rigid mounting of the known skid plate is cited in U.S. Pat. No. 6,516,907 Engine Mounted Skid Plates, in which the known skid plate is directly mounted to an engine or transmission of a vehicle thereby utilizing the energy absorption characteristics of the engine or transmission mounts. While this may accomplish the reduction of impact force transmitted to the vehicle, it may also over tax the integrity of the engine or transmission mounts whose primary function and design is to provide vibration isolation, support of the engine or transmission, and on some new vehicles to collapse or break away in the event of a collision, not to withstand repeated impacts with immoveable objects.

Moreover, the design and rigid mounting of known skid plates restricts access to undercarriage components which may need routine maintenance or repair. Removal of the entire known skid plate may be necessary to gain the access needed for the maintenance. Removal of the known skid plate is often cumbersome, requiring additional tools and adding labor time to perform the maintenance.

Therefore, there is opportunity for innovation in the art for a skid plate which has a means to reduce the coefficient of drag when in contact with a hazard or obstacle, provides for some impact absorption, and facilitates easy access to the undercarriage components of the vehicle for maintenance purposes.

### SUMMARY OF THE INVENTION

The present invention is directed toward a skid plate having a plurality of rollers to facilitate the motion of a land vehicle during encounters between said skid plate and trail hazards, obstacles, and other immovable objects. The skid plate may have a rigid frame which houses the rollers and provides structural integrity for the skid plate. The frame may also provide housing for polymer based impact absorbing bushings to be used in mounting of the skid plate. The present invention is further directed toward a skid plate possessing mounting brackets which incorporate a quick disconnect mechanism to facilitate the removal and installation of the skid plate.

### BRIEF DESCRIPTION OF THE DRAWINGS

FIG. 1 is a perspective view of the complete assembly of the preferred embodiment of the present invention;

FIG. 2 is a perspective view of only the structural rigid frame and isolation mounts of the preferred embodiment of the present invention;

FIG. 3 is an exploded view of the components comprising the roller assembly of the preferred embodiment of the present invention;

FIG. 4 is a perspective view of a side mounting bracket used in the preferred embodiment of the present invention;

FIG. 5 is a perspective view of a rear mounting bracket used in the preferred embodiment of the present invention;

FIG. 6 is an exploded view of the components comprising the quick release mechanism used in the preferred embodiment of the present invention;

FIG. 7 is an exploded view of the components comprising the isolation mounts used in the preferred embodiment of the present invention;

FIG. 8 is a side elevation view of the preferred embodiment of the present invention mounted in a typical configuration to a motorized land vehicle.

### DESCRIPTION OF THE PREFERRED EMBODIMENT

This detailed description conveys the best mode contemplated for carrying out the present invention. The intention of this description is not to project exclusivity of the mode described herein, and as such mention of possible deviations, permutations, and modifications foreseen in the execution of the present invention will additionally be mentioned.

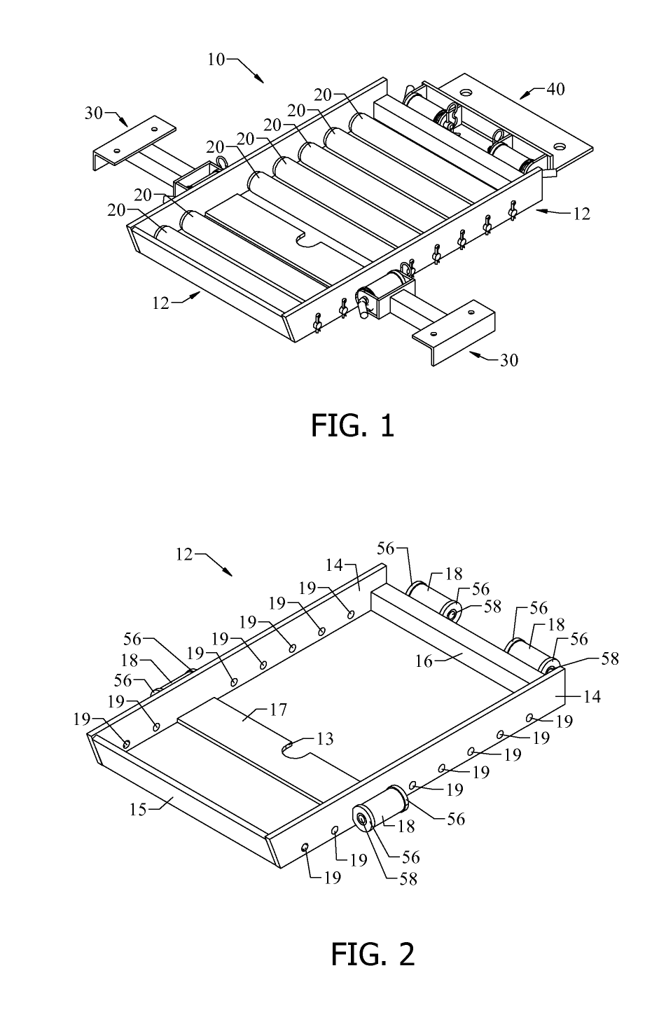

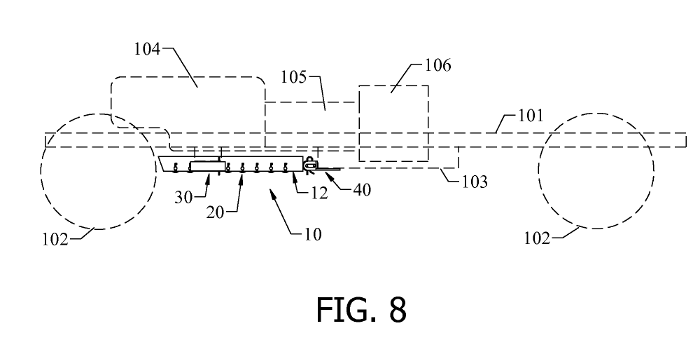

Referring to FIG. 1, the roller skid plate assembly 10 is composed of a rigid frame 12 for housing the plurality of rollers 20. This embodiment of the present invention includes seven rollers 20. The actual number of rollers 20 may vary depending on the size of the vehicle, the component which the skid plate 10 is protecting, and other vehicle features which may warrant a quantity of rollers 20 more or less than seven. As seen in FIG. 8, the roller skid plate 10 is connected to the frame 101 or unit body structure of the land vehicle via mounting brackets. This embodiment of the present invention references two side mounting brackets 30 and one rear mounting bracket 40. The location and quantity of the mounting brackets may vary in accordance with vehicle dimensions and availability of mounting locations.

FIG. 2 depicts the typical rigid frame 12. The rigid frame 12 may be constructed of steel, aluminum, or other metal alloy members with sufficient strength of materials to provide protection from all foreseen impacts which the present invention may encounter in use as an off-road vehicle skid plate. Furthermore the material used for the rigid frame 12 must possess characteristics which enable the rigid frame 12 to withstand other hazards including but not limited to extreme heat, extreme cold, contact with chemicals, and contact with hard objects encountered in use as an off-road vehicle skid plate. The rigid frame may have two side members 14 which are oriented parallel to the left and right side of the vehicle. Attached between and perpendicular to the two side members 14 may be a front member 15, a rear member 16, and a center member 17. The preferred method of connecting the members to form the rigid frame 12 is welding; however removable fasteners, metal forming, or other bonding methodologies may also be used. A slot 13, hole, or cut-out may be formed in the center member 17 to facilitate access to a drain plug or other vehicle component which may require frequent access. The two side members 14 of the rigid frame may contain a plurality of holes 19 to provide means for locating and supporting of the rollers 20. The holes 19 on each side member 12 must be directly opposite holes on the opposing side member 12 and situated in such a way as to provide the axes of rotation of the rollers 20 are parallel to the axes of rotation of the wheels 102 of the vehicle. Attached to the rigid frame 12 are bushing housings 18. The bushing housings 18 may be attached to the rigid frame 12 by means of welding. Positioning of the bushing housings 18 may depend on vehicle geometry and location of convenient mounting locations on frame 101 of the vehicle.

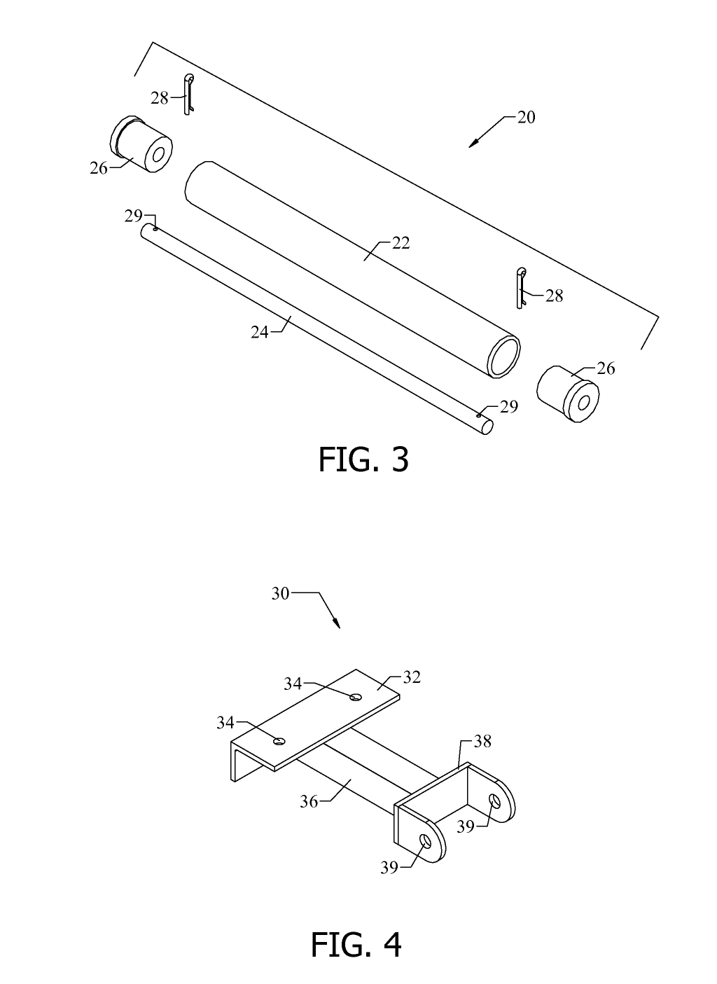

This present invention includes rollers 20 which may be constructed of a length of DOM (Drawn Over Mandrel) tubing 22 which may be cut to the appropriate length for the size of the rigid frame 12. The outside diameter in combination with the inside diameter of the tubing 22 should be in such proportion as to provide sufficient strength to withstand impacts with road hazards whilst minimizing the loss of ground clearance of the vehicle to which the roller skid plate 10 is attached. As seen in FIG. 3, located at both ends of the length of DOM tubing 22 are bushings 26 which are inserted into the length of DOM tubing 22 and may be retained by a friction fit. The roller bushings 26 may be made of a high strength polymer material which exhibits low coefficient of friction. Each bushing 26 has a concentric through hole in which the axle rod 24 passes through. Those skilled in the art will understand the workings of an axle rod and roller. In this present invention the axle rod 24 extends beyond the outside edge of both rigid frame 12 side members 14. A cotter pin 28 may be used at each end of the axle rod 24 as a retention device to prevent the axle rod 24 from sliding through either side members 14 of the rigid frame 12. Other commonly available retention means may be employed, such as c-clips, axle nuts, or threaded fasteners.

The two side mounting brackets 30 used in this present invention can be seen with more detail in FIG. 4. The side brackets serve the function of attaching the rigid frame 12 of the present invention to the frame 101 or unit body structure of the vehicle. One end of the bracket is rigidly and removably attached to the vehicle whilst the other end is attached to the rigid frame 12. The end of the side mounting bracket 30 which attaches to the vehicle may be constructed of steel angle iron 32 or other structural steel profiles. The angle iron 32 segment may have holes 34 to facilitate the use of threaded fasteners as means of attachment to the vehicle. The center segment 36 of the side mounting bracket 30 may be constructed of square tube or other structural steel profiles. The length of the center segment 36 is dependent on the distance between the location of mounting to the vehicle and the side member 14 of the rigid frame 12. The center segment 36 may incorporate some bends or twists to accommodate clearance around vehicle components such as drive-shafts, exhaust pipes, and the like. The other end of the side mounting bracket 30 provides the means for attachment to the rigid frame 12. This end may be constructed of flat steel welded together to form a U-shaped member 38. The U-shaped member 38 has two opposing holes 39 to allow for the quick release pin 52 to be extended through the side mounting bracket 30. All three segments of the side mounting bracket 30 may be welded together, forming one solid bracket.

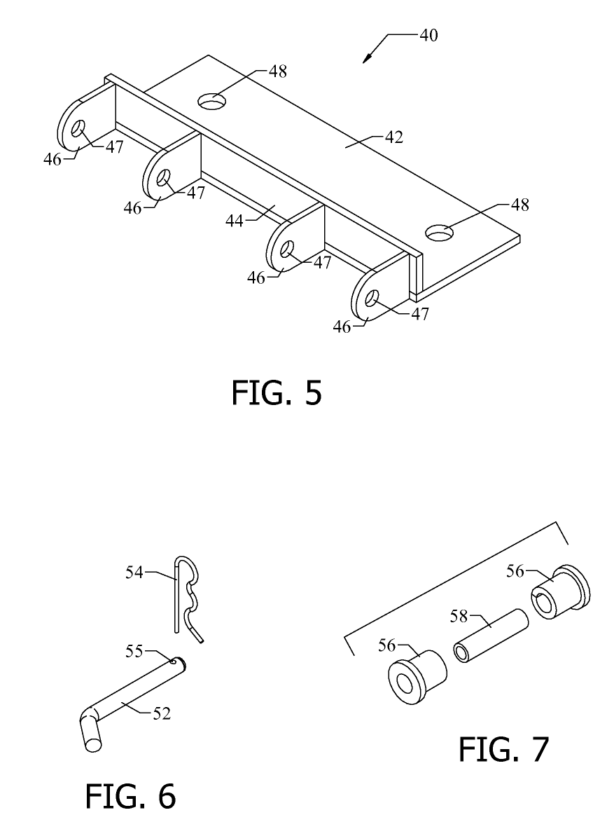

The present invention includes one rear mounting bracket 40, as seen in FIG. 5, used to secure the rigid frame 12 to a structural cross member of the frame 101 or a factory installed transfer case skid plate 103 of the vehicle. The rear mounting bracket 40 is similar in construction to the side mounting brackets 30 and serves the same function. The rear mounting bracket 40 may be constructed of a flat steel base member 42 welded to an upright forward facing flat steel member 44. The upright forward facing member 44 is useful to stiffen the rear mounting bracket 40 and to provide a surface for attaching the cantilevered mounting arms 46. Holes 47 in the cantilever arms 46 may be used for assembly to the rigid frame 12 by means of the quick release pin 52. Welding may be the preferred method of attaching the cantilevered mounting arms 46 to the rear mounting bracket 40. Metal forming with a brake press is another method of fabrication which may be employed in the construction of the rear mounting bracket 40 without deviating from the intent of the present invention. Holes 48 in the flat base member 42 may be used to provide means for rigidly and removable mounting the rear mounting bracket 40 to a cross member or transfer case skid plate 103 of the vehicle.

Referring to FIG. 6 and FIG. 7, it can be seen the means of connecting the side mounting brackets 30 and the rear mounting bracket 40 to the rigid frame 12 employs the use of an assembly consisting of a hitch pin 52, a hair clip pin 54, two isolation bushing halves 56 and a cylindrical sleeve 58. The two bushing halves 56 are inserted into opposing ends of the bushing housing 18 on the rigid frame 12, until the shoulder of the bushings 56 seat against the ends of the bushing housing 18. The cylindrical sleeve 58 is inserted through the center of the two bushing halves 56 with a tight friction fit and resulting with both ends of the cylindrical sleeve 58 approximately being flush with the outside ends of each bushing half 56. Those skilled in the art will realize this arrangement is very similar to the arrangement of a typical leaf spring bushing found in many motorized land vehicles. The bushing halves 56 may be made of a rubber or polyurethane compound which will provide impact absorption during encounters between the roller skid plate 10 and road hazards.

In field application of the present invention, the preferred method of assembly would be to removably attach both side mounting brackets 30 and rear mounting bracket 40 to the land vehicle frame 101, unit body structure, cross member, or transfer case skid plate, using high strength threaded fasteners. The next step would be connecting of the rigid frame 12 to either the side mounting brackets 30 or the rear mounting bracket 40 which may be accomplished using the quick release pins 52 and clips 54. The roller skid plate 10 rigid frame 12 is positioned such that the center of the bushing halves 56 in the bushing housing 18 are aligned to the holes 39 in the side mounting bracket or the holes 47 in the rear mounting bracket, the quick release pin 52 is then inserted through one of the holes 39 or 47 and continuing through the cylindrical sleeve 58 and finishing through the opposing hole 39 or 47. A hair clip type pin 54 is then inserted in the hole 55 found at the end of the quick release pin 52 to prevent the quick release pin 52 from accidental removal. The preferred sequence of attachment in the present invention would be to connect the rear mounting bracket 40 first, followed by one and then the other side mounting bracket 30. Removal of the rigid frame 12 for the purpose of gaining access to vehicle components for repair or maintenance, or to just remove the rigid frame 12 from the vehicle is accomplished by reversing the order of attachment outlined above.

FIG. 8 depicts the roller skid plate 10 in a typical configuration mounted to a motorized land vehicle. In this configuration the roller skid plate 10 is providing protection to the engine 104 and a portion of the transmission 105. The transfer case 106 is protected by a factory installed skid plate 103, to which the rear mounting bracket 40 is removably attached.

What is claimed is:

1. A roller skid plate to protect undercarriage components of a land vehicle comprising:
a frame;
a plurality of rollers mounted in said frame; and,
a plurality of mounting brackets used to attach said frame to said land vehicle.

2. The roller skid plate according to claim 1, wherein said frame having two side members parallel to each other, a front member and a rear member permanently attached between and perpendicular to said side members, forming a rectangular shaped frame.

3. The roller skid plate according to claim 1, wherein said frame having two side members parallel to each other, a front member, a rear member, and a center member are permanently attached between and perpendicular to said side members, forming a ladder shaped frame.

4. The roller skid plate according to claim 1, wherein said plurality of rollers are mounted to said frame via axle rods such that when said frame is mounted to said land vehicle, the axes of rotation of said rollers are parallel to the axes of rotation of the wheels of said land vehicle.

5. The roller skid plate according to claim 4, wherein each of said plurality of axle rods is retained in said skid plate frame by means of two cotter pins.

6. The roller skid plate according to claim 1, wherein each of said plurality of rollers employs a polymer bushing at each end to act as a bearing.

7. The roller skid plate according to claim 1, wherein each of said plurality of rollers employs a roller bearing at each end.

8. The roller skid plate according to claim 1, wherein a plurality of isolation bushings are housed in said roller skid plate frame.

9. The roller skid plate according to claim 8, wherein each of said plurality of mounting brackets are releasably attached at one end, by means of a quick release mechanism, to each of said plurality of isolation bushings mounted in said roller skid plate frame.

10. The roller skid plate according to claim 1, wherein each of said plurality of mounting brackets are releasably attached at one end to said land vehicle frame, unit body structure, or structural member.

11. The roller skid plate according to claim 1, wherein each of said plurality of mounting brackets are permanently attached at one end to said land vehicle frame, unit body structure, or structural member.

12. The roller skid plate according to claim 1, wherein said plurality of mounting brackets includes two side mounting brackets and one rear mounting bracket in relation to the orientation of said land vehicle.

13. The roller skid plate according to claim 1, wherein said plurality of mounting brackets includes two side brackets and one front bracket in relation to the orientation of said land vehicle.

14. The roller skid plate according to claim 1, wherein said plurality of mounting brackets includes a total of four side mounting brackets, two on each side, and none on the front or rear side of said roller skid plate in relation to the orientation of said land vehicle.
